(19) United States
(12) Patent Application Publication
(10) Pub. No.: US 2007/0120344 A1
(43) Pub. Date: May 31, 2007

(54) Motorcycle support stand system

(76) Inventor: Stephen C. Johnson, Grand Rapids, MN (US)

Correspondence Address: NEUSTEL LAW OFFICES, LTD., 2534 SOUTH UNIVERSITY DRIVE, SUITE 4, FARGO, ND, 58103, US

(21) Appl. No.: 11/291,763

(22) Filed: Nov. 30, 2005

(51) Int. Cl. B62H 1/02

(52) U.S. Cl. 280/303

(57) ABSTRACT

A motorcycle support stand system for efficiently supporting a motorcycle in an upright position. The motorcycle support stand system includes a base member adapted to be attached to a motorcycle, an upper support member pivotally attached to the base member in a biased manner, a lower support member pivotally attached to the upper support member in a biased manner, and a lever attached to the lower support member.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to motorcycle support stands and more specifically it relates to a motorcycle support stand system for efficiently supporting a motorcycle in an upright position.

2. Description of the Related Art

Any discussion of the prior art throughout the specification should in no way be considered as an admission that such prior art is widely known or forms part of common general knowledge in the field.

Motorcycle support stands have been in use for years. Some motorcycle support stands completely lift the motorcycle for extended storage and the like to remove relieve compression of the suspension. Other motorcycle support stands are comprised of a kickstand structure that extends to the side of the motorcycle to support the motorcycle in a leaning manner.

While these devices may be suitable for the particular purpose to which they address, they are not as suitable for efficiently supporting a motorcycle in an upright position. In these respects, the motorcycle support stand system according to the present invention substantially departs from the conventional concepts and designs of the prior art, and in so doing provides an apparatus primarily developed for the purpose of efficiently supporting a motorcycle in an upright position.

### BRIEF SUMMARY OF THE INVENTION

In view of the foregoing disadvantages inherent in the known types of motorcycle support stands now present in the prior art, the present invention provides a new motorcycle support stand system construction wherein the same can be utilized for efficiently supporting a motorcycle in an upright position.

The general purpose of the present invention, which will be described subsequently in greater detail, is to provide a new motorcycle support stand system that has many of the advantages of the motorcycle support stands mentioned heretofore and many novel features that result in a new motorcycle support stand system which is not anticipated, rendered obvious, suggested, or even implied by any of the prior art motorcycle support stands, either alone or in any combination thereof.

To attain this, the present invention generally comprises a base member adapted to be attached to a motorcycle, an upper support member pivotally attached to the base member in a biased manner, a lower support member pivotally attached to the upper support member in a biased manner, and a lever attached to the lower support member.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a motorcycle support stand system that will overcome the shortcomings of the prior art devices.

A second object is to provide a motorcycle support stand system for efficiently supporting a motorcycle in an upright position.

Another object is to provide a motorcycle support stand system that may be utilized upon various types of motorcycles.

Another object is to provide a motorcycle support stand system for displaying, parking, storing, cleaning, hauling, repairing and maintaining a motorcycle.

Another object is to provide a motorcycle support stand system that is stable.

Another object is to provide a motorcycle support stand system that is simple to install.

Another object is to provide a motorcycle support stand system that does not detract from the appearance of a motorcycle when attached.

An additional object is to provide a motorcycle support stand system that allows a user to easily set a motorcycle into an upright position without significant physical effort.

Another object is to provide a motorcycle support stand system that does not interfere with the operation of the motorcycle.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention attached to the frame of a motorcycle.

FIG. 2 is an exploded side view of the present invention.

FIG. 3 is an exploded upper perspective view of the present invention with respect to a motorcycle frame.

FIG. 4 is a bottom view of the present invention.

FIG. 5 is a top view of the present invention.

FIG. 6 is a side view of the present invention attached to a motorcycle and in the raised position.

FIG. 7 is side view of the present invention attached to a motorcycle and partially extended downwardly.

FIG. 8 is side view of the present invention attached to a motorcycle and partially extended downwardly with the lower portion extended into a substantially parallel position with the upper portion.

FIG. 9 is a side view of the present invention in the lowered position supporting the motorcycle.

### DETAILED DESCRIPTION OF THE INVENTION

A. Overview

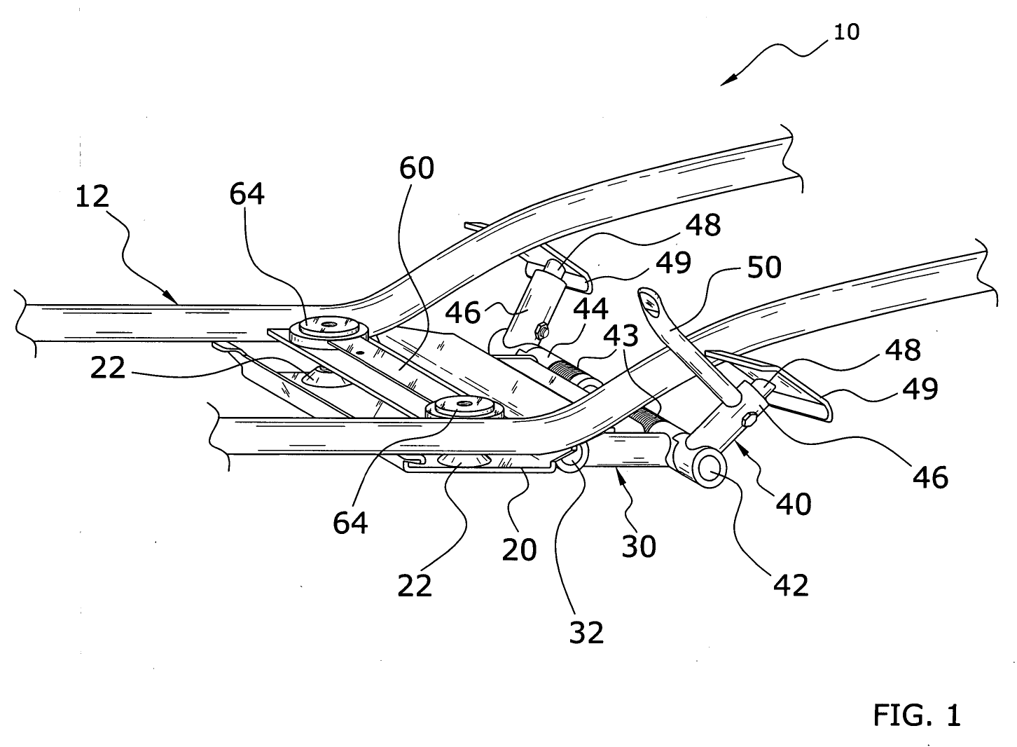

Turning now descriptively to the drawings, in which similar reference characters denote similar elements throughout the several views, FIGS. 1 through 9 illustrate a motorcycle support stand system 10, which comprises a base member 20 adapted to be attached to a motorcycle, an upper support member 30 pivotally attached to the base member 20 in a biased manner, a lower support member 40 pivotally attached to the upper support member 30 in a biased manner, and a lever 50 attached to the lower support member 40.

B. Base Member

The base member 20 is adapted to be attached to a frame 12 of a motorcycle as illustrated in FIGS. 1, 2, 6, 7, 8 and 9 of the drawings. The base member 20 preferably is comprised of a relatively flat structure and has four raised corner portions that engage the bottom surface of the motorcycle frame 12 when attached to the frame 12.

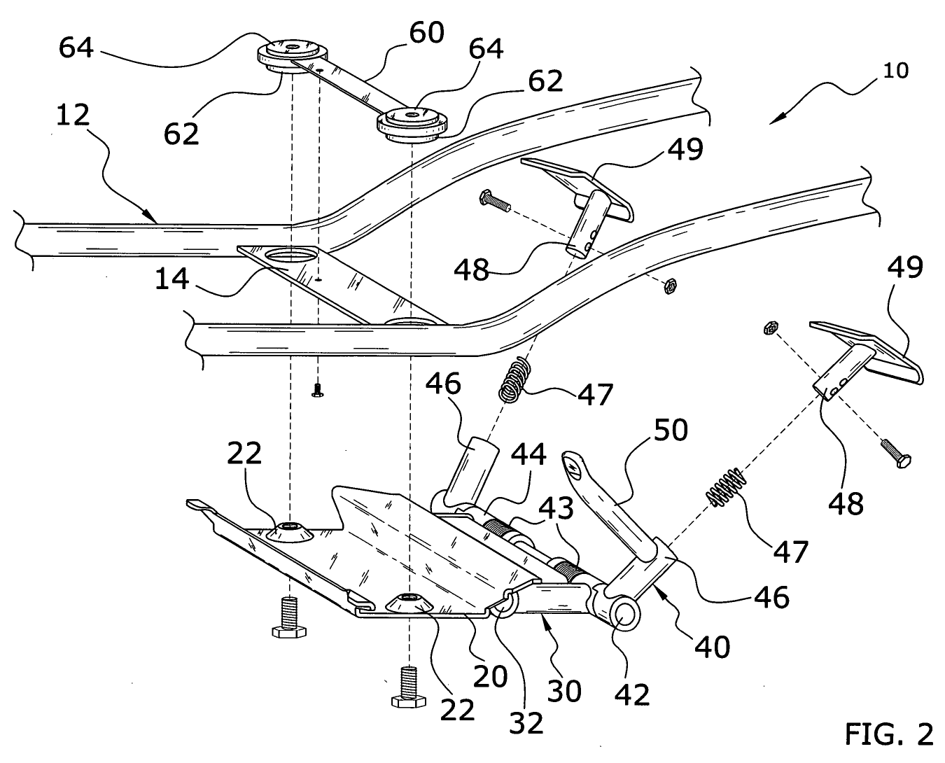

The base member 20 preferably includes a pair of raised portions 22 that have apertures within for receiving fastener bolts as best illustrated in FIG. 2 of the drawings. The fastener bolts extend upwardly and threadably engage threaded apertures within a nut plate 60 that is positioned on an opposite side of the cross brace 14 of the motorcycle frame 12 as illustrated in FIGS. 1 and 2 of the drawings.

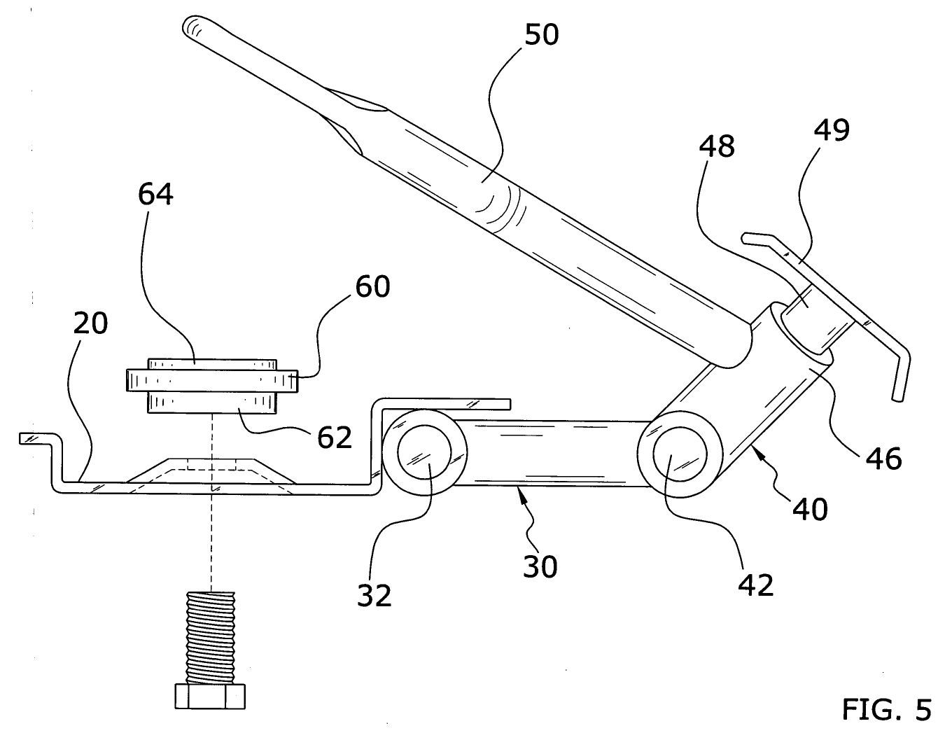

The nut plate 60 may be comprised of any structure that fits onto a cross brace 14 and wherein the threaded apertures within the nut plate 60 are aligned with the apertures within the cross brace 14. The nut plate 60 preferably includes a pair of first portions 62 and a pair of opposing second portions 64 that have different thicknesses and to match different cross brackets utilized upon different models of motorcycle frames 12 as illustrated in FIGS. 2 and 5 of the drawings.

C. Upper Support Member

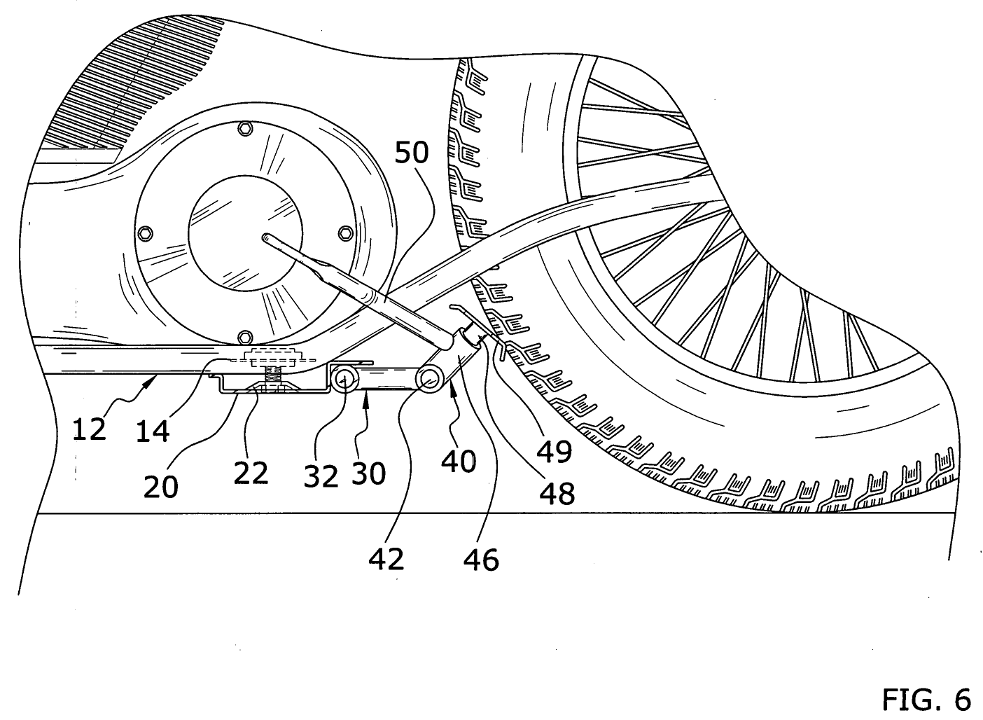

The upper support member 30 is pivotally attached to the base member 20 by a first hinge 32 or similar hinge structure. The upper support member 30 preferably is biased into a raised position by at least one first spring 34, wherein the first spring 34 engages the upper support member 30 and the base member 20. The first spring 34 maintains the upper support member 30 in a substantially horizontal position when in the raised position as best illustrated in FIGS. 1 and 6 of the drawings. The first spring 34 is preferably comprised of a torsion spring, however other biasing devices may be utilized to bias the upper support member 30.

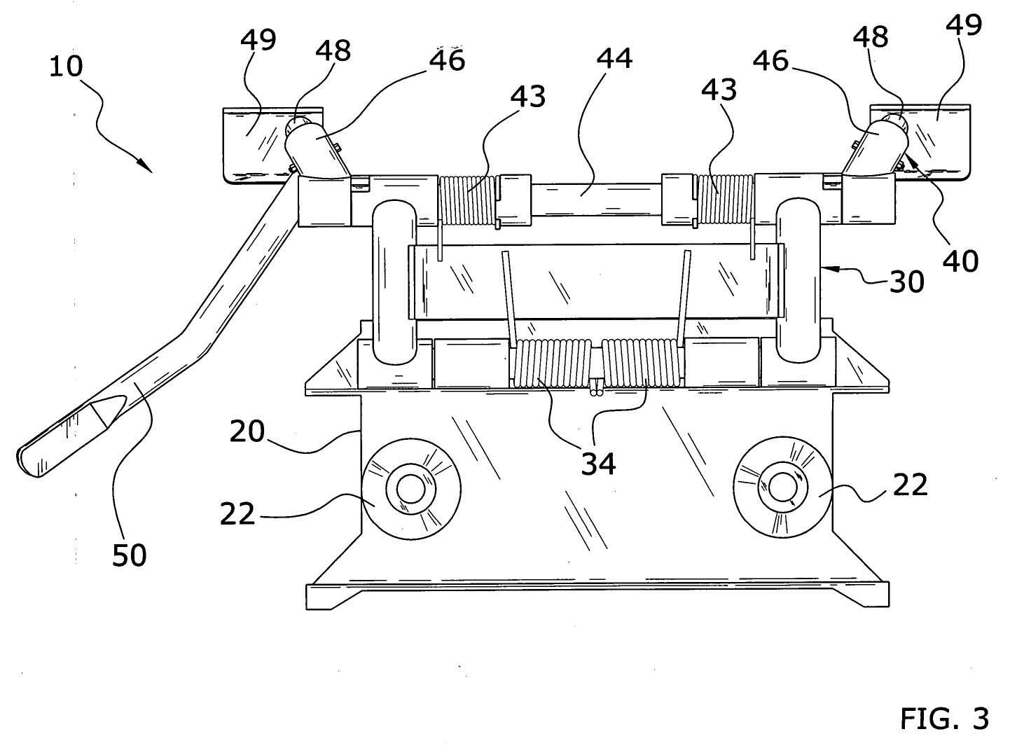

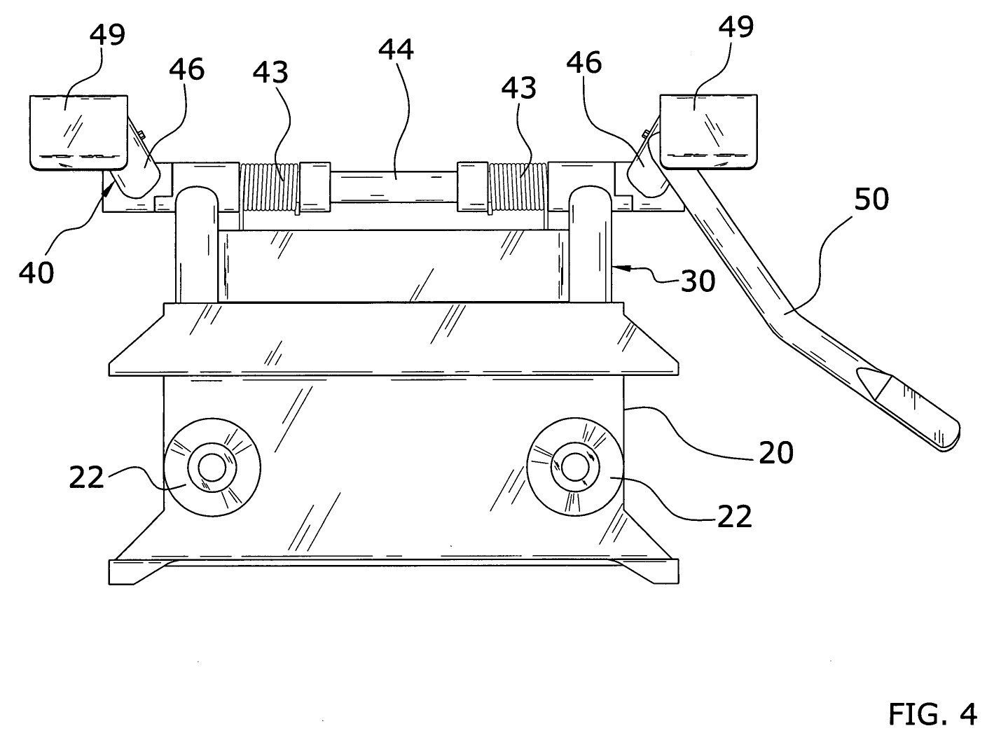

As best illustrated in FIGS. 3 and 4 of the drawings, the upper support member 30 is preferably comprised of a U-shaped structure having opposing side members and a cross member. Various other structures may be utilized to construct the upper support member 30 other than illustrated in the figures.

D. Lower Support Member

The lower support member 40 pivotally attached to the upper support member 30 by a second hinge 42 as illustrated in FIGS. 1 through 9 of the drawings. The lower support member 40 is preferably biased by at least one second spring 43 engaging the lower support member 40 and the upper support member 30. The biasing force applied by the second spring 43 maintains the lower support member 40 in a substantially upwardly angled position when the present invention is in the raised position as best illustrated in FIGS. 1 and 6 of the drawings. The second spring 43 is preferably comprised of a torsion spring, however other biasing devices may be utilized to bias the upper support member 30.

The lower support member 40 is preferably comprised of a pair of support units pivotally extending from the upper support member 30. The pair of support units are preferably connected to one another in a non-rotational manner by a cross support 44 or related structure to ensure that they are both lowered and raised simultaneously. The pair of support units also preferably extend outwardly with respect to the upper support member 30 to provide a broader base support when engaging a ground surface.

The pair of support units are each preferably comprised of a receiver tube 46 and a leg 48 adjustably positioned within the receiver tube 46 as best illustrated in FIGS. 1 and 2 of the drawings. A compression spring 47 is preferably positioned within the receiver tube 46 and abutted against an inner end of the leg 48 to applying an outwardly biasing force to each leg 48, wherein the leg 48 is slidably positioned within the receiver tube 46 for adjustment.

A plurality of apertures preferably extend through the leg 48 as illustrated in FIG. 2 of the drawings. Another aperture extends through the receiver tube 46 for receiving a fastener that extends through the apertures within the receiver tube 46 and through a desired aperture within the leg 48 for securing the leg 48 in a desired extended position. The adjustability of the legs 48 with respect to the receiver tubes 46 allows the user to both level the motorcycle and also ensure that the appropriate upward force is applied to the motorcycle frame 12 when the present invention is in the lowered position.

As best illustrated in FIGS. 2 through 4 of the drawings, a pad 49 is attached to a distal portion of each leg 48. The pad 49 is comprised of a relatively broad structure to disperse the weight of the motorcycle for supporting the same on various ground surfaces. The pad 49 preferably has an angled front edge and an angled rear edge, wherein the angle of the front end is more than the angle of the rear edge as best illustrated in FIG. 5 of the drawings.

E. Lever

The lever 50 attached to the lower support member 40 as shown in FIGS. 1 through 9 of the drawings. The lever 50 is attached to a receiver tube 46 (or a leg 48) as illustrated in FIGS. 1 and 2 of the drawings. The lever 50 is preferably angled outwardly from the lower support member 40 as best illustrated in FIGS. 3 and 4 of the drawings. The lever 50 preferably has an inner segment and an outer segment, wherein the outer segment is angled outwardly more from the inner segment as further shown in FIGS. 1 and 2 of the drawings. The outer end of the lever 50 is preferably comprised of a relatively flat structure.

F. Operation of Invention

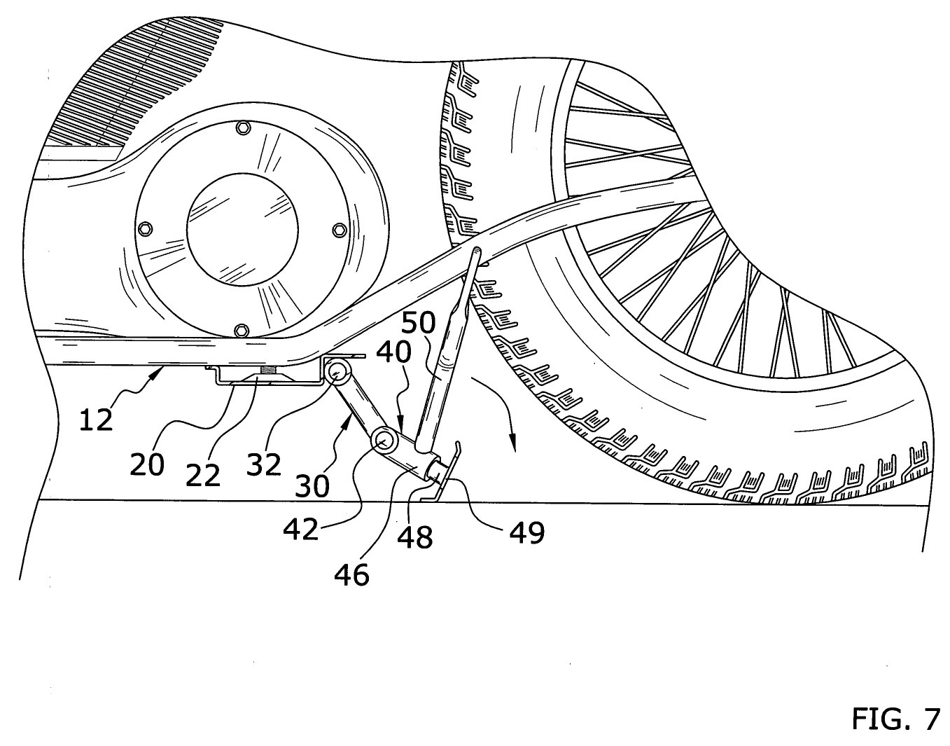

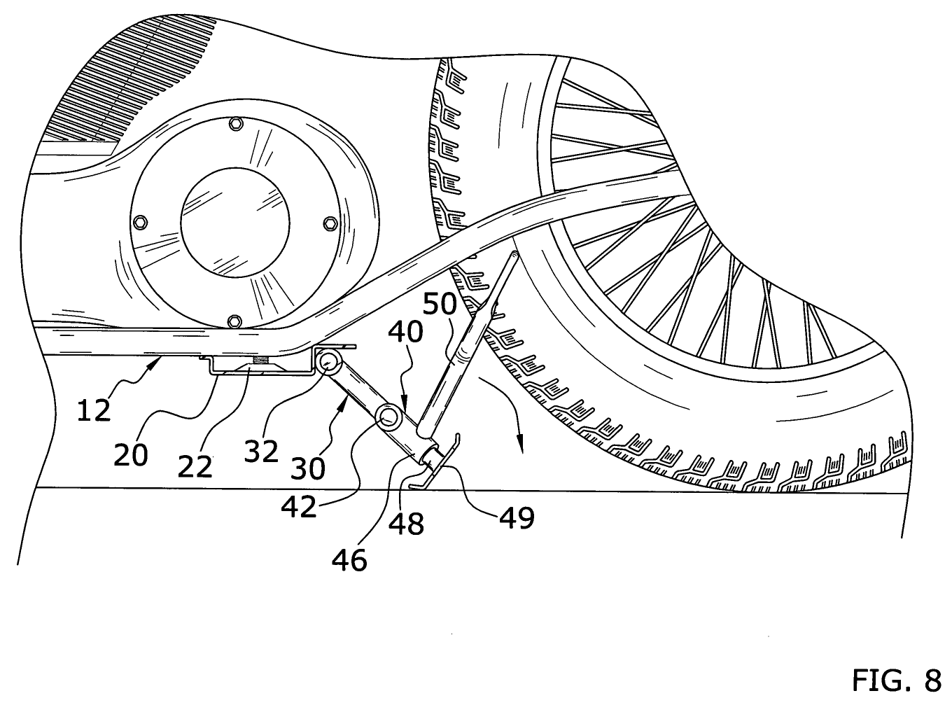

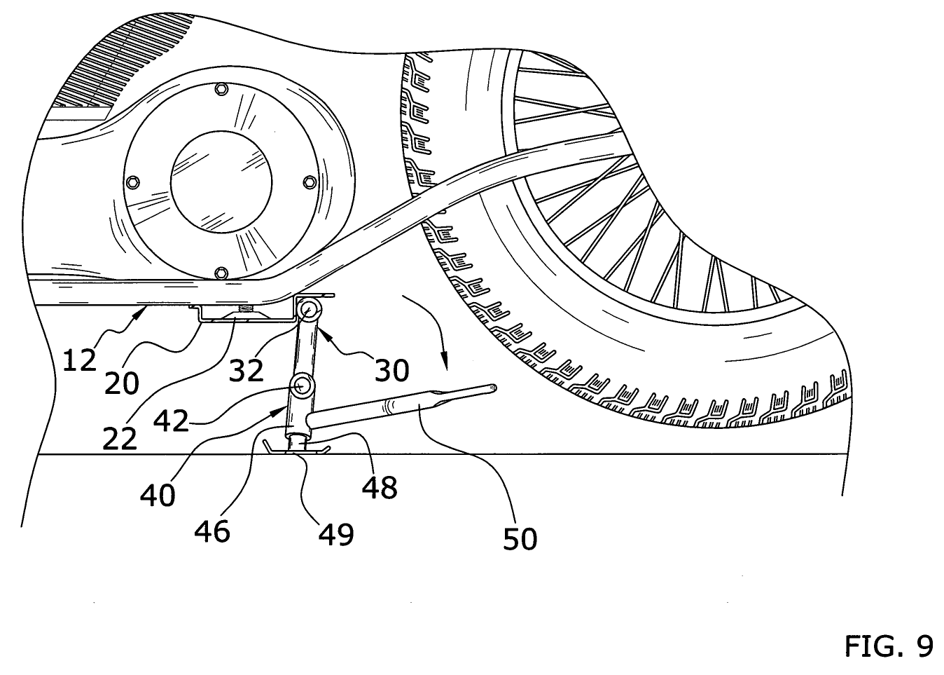

In use, the base member 20 is attached to the frame 12 of the motorcycle as illustrated in FIGS. 1 and 2 of the drawings. The motorcycle may be operated as normal without interference of operation by the present invention as illustrated in FIG. 6 of the drawings. If the user desires to park the motorcycle, the user lifts upwardly and rearwardly upon the distal portion of the lever 50 thereby pivoting both the upper support member 30 and the lower support member 40 in a clockwise manner (when facing the left-side of the motorcycle) as shown in FIG. 7 of the drawings. When the pad 49 of the lower support member 40 first engages the ground surface, the lower support member 40 is generally at an angle with respect to the upper support member 30 and the lever 50 is slightly past ninety-degrees as further shown in FIG. 7 of the drawings. The user then continues the rotation of the lever 50 in a clockwise manner by pressing rearwardly and downwardly upon the distal portion of the lever 50, wherein the pad 49 substantially remains positioned upon the ground surface and the lower support member 40 is aligned substantially parallel to the upper support member 30 as shown in FIG. 8 of the drawings. The user continues to rotate the lever 50 in the clockwise direction thereby causing the motorcycle to be lifted upward and rearward until the upper support member 30 engages a rear edge of the base member 20 thereby preventing further clockwise rotation of the upper support member 30 as shown in FIG. 9 of the drawings. When the present invention is in the fully lowered position as shown in FIG. 9 of the drawings, the upper support member 30 and the lower support member 40 are maintained in an aligned position because of the over centering downward force of the motorcycle. It is preferable that the lower support member 40 is adjusted so that both tires of the motorcycle remain upon the ground surface with only a portion of the weight of the motorcycle transferred to the present invention thereby increasing the stability of the motorcycle in the parked position. When the user desires to operate the motorcycle again, the user simply pushes the motorcycle forward to move past the over centering of the present invention thereby allowing the upper support member 30 to rotate counterclockwise until it is back into the horizontal storage position as shown in FIG. 6 of the drawings. The lower support member 40 is allowed to pivot upwardly with respect to the upper support member 30 also thereby elevating the distal portions of the lower support member 40 above the ground surface further to reduce the likelihood of engagement of the road surface during turning and also increasing the visual appearance of the motorcycle.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. A motorcycle support stand system, comprising:
a base member adapted to be attached to a motorcycle;
an upper support member pivotally attached to the base member;
a lower support member pivotally attached to the upper support member; and
a lever attached to the lower support member.

2. The motorcycle support stand system of claim 1, wherein said upper support member is biased by a first spring engaging said upper support member and said base member to maintain said upper support member in a substantially horizontal position when in a raised position.

3. The motorcycle support stand system of claim 2, wherein said lower support member is biased by a second spring engaging said lower support member and said upper support member to maintain said lower support member in a substantially upwardly angled position when in a raised position.

4. The motorcycle support stand system of claim 1, wherein said upper support member is comprised of a first hinge attached to said base member.

5. The motorcycle support stand system of claim 1, wherein said upper support member is comprised of a U-shaped structure.

6. The motorcycle support stand system of claim 1, wherein said lower support member is comprised of a pair of support units.

7. The motorcycle support stand system of claim 6, wherein said pair of support units extend outwardly with respect to said upper support member.

8. The motorcycle support stand system of claim 6, wherein said pair of support units are each comprised of:
a receiver tube; and
a leg adjustably positioned within said receiver tube.

9. The motorcycle support stand system of claim 8, wherein said pair of support units each include a compression spring positioned within said receiver tube and abutted against an inner end of said leg.

10. The motorcycle support stand system of claim 8, wherein said pair of support units each include a plurality of apertures and a fastener for extending through a corresponding hole within said receiver tube for securing said leg in a desired extended position.

11. The motorcycle support stand system of claim 8, wherein said pair of support units each include a pad attached to a distal portion thereof.

12. The motorcycle support stand system of claim 6, including a cross support attached between said pair of support units.

13. The motorcycle support stand system of claim 1, including a second hinge attached between said upper support member and said lower support member.

14. A motorcycle support stand system, comprising:
a base member adapted to be attached to a motorcycle;
an upper support member pivotally attached to the base member by a first hinge, wherein said upper support member is biased by a first spring engaging said upper support member and said base member to maintain said upper support member in a substantially horizontal position when in a raised position;
a lower support member pivotally attached to the upper support member by a second hinge, wherein said lower support member is biased by a second spring engaging said lower support member and said upper support member to maintain said lower support member in a substantially upwardly angled position when in a raised position;
wherein said lower support member is comprised of a pair of support units, wherein said pair of support units extend outwardly with respect to said upper support member, and wherein said pair of support units are each comprised of:
a receiver tube;
a leg adjustably positioned within said receiver tube;
a compression spring positioned within said receiver tube and abutted against an inner end of said leg;
a plurality of apertures and a fastener for extending through a corresponding hole within said receiver tube for securing said leg in a desired extended position;
a pad attached to a distal portion thereof; and
a cross support attached between said pair of support units; and
a lever attached to the lower support member.

15. The motorcycle support stand system of claim 14, wherein said upper support member is comprised of a U-shaped structure.
